(19) United States
(12) Patent Application Publication
(10) Pub. No.: US 2013/0152212 A1
(43) Pub. Date: Jun. 13, 2013

(54) DEPERSONALIZED SEARCH

(71) Applicant: DISCONNECT, INC., Menlo Park, CA (US)

(72) Inventor: BRIAN JONATHAN KENNISH, San Francisco, CA (US)

(73) Assignee: DISCONNECT, INC., Menlo Park, CA (US)

(21) Appl. No.: 13/712,648

(22) Filed: Dec. 12, 2012

Related U.S. Application Data
(60) Provisional application No. 61/569,554, filed on Dec. 12, 2011.

(51) Int. Cl. H04L 29/06

(52) U.S. Cl. CPC H04L 63/0407
USPC 726/26

(57) ABSTRACT

Methods and systems for managing a search process are provided. One method includes receiving user information from a user application, the user information associated with a search provider maintaining search services and non-search services. The method further includes transmitting the user information to the search provider, and receiving one or more cookies from the search provider. The method also includes receiving a user request from a user application, the user request addressed to the search provider, comparing the user request to a list of non-search services maintained by the search provider, and, upon determining that the user request is associated with a search service, transmitting the user request to the search service without transmitting the one or more cookies.

### CROSS-REFERENCE TO RELATED APPLICATIONS

The present application claims priority to U.S. Provisional Patent Application No. 61/569,554, filed Dec. 12, 2011, the disclosure of which is hereby incorporated by reference in its entirety.

### TECHNICAL FIELD

The present disclosure relates generally to user information management. In particular, the present disclosure relates to a depersonalized search system.

### BACKGROUND

Search providers like Google, Yahoo, and Microsoft record the keywords of their users' searches. If these users are logged into any of the providers' other services like Google's YouTube, Yahoo's Flickr, or Microsoft's Hotmail, the providers connect the search keywords to the users' accounts to deliver personalized search results and more targeted ads.

In particular, major search providers record and connect users' search history to personal profiles through cookies and single sign-on (SSO). SSO is a method of enabling users to be authenticated against one service then granted access to many services. For instance, Google employs SSO so a user that logs into Gmail is automatically logged into other Google services. Google drops generic cookies on the user's browser such that user-identifying data is sent to Google's primary domain (google.com) as well as all subdomains (e.g., mail.google.com) and paths (e.g., google.com/calendar), where search and other services are hosted. Thus, Google is able to personally track the user's search activity when the user is logged into any Google service. Other major search providers do the same.

There are currently no easy-to-use solutions under control of a searcher that effectively allow that searcher to sign into providers' other services and stop the providers from logging search terms and personalizing search results.

Because the privacy concerns posed by personalized search tracking are so significant, consumers increasingly demand solutions. Some browser vendors increasingly support “Private Browsing” or “Incognito” modes, but these solutions are far from satisfactory due to inconvenience and lack of availability across browsers and platforms.

For the above and other reasons, improvements are desirable.

### SUMMARY

In accordance with the following disclosure, the above and any other issues are addressed by the following:

In a first aspect, a method for managing a search process is provided. One method includes receiving user information from a user application, the user information associated with a search provider maintaining search services and non-search services. The method further includes transmitting the user information to the search provider, and receiving one or more cookies from the search provider. The method also includes receiving a user request from a user application, the user request addressed to the search provider, comparing the user request to a list of non-search services maintained by the search provider, and, upon determining that the user request is associated with a search service, transmitting the user request to the search service without transmitting the one or more cookies.

In a second aspect, a method of managing a search process includes receiving user login information from a user application, the user login information associated with a data provider, and transmitting the user login information to the data provider. The method also includes receiving a user request from a user application, the user request addressed to the data provider and associated with a service provided by the data provider, the user request including user-identifying information. The method further includes, based at least in part on the identity of a service, transmitting the user request to the data provider without transmitting the user-identifying information.

In a third aspect, an application extension includes a cookie-rewriter component and a cookie-blocker component. The cookie-rewriter component executes on a user computer and maintains a list of a plurality of subdomains and paths associated with non-search services of a search provider. The cookie-rewriter component is configured to receive a generic cookie from a service of a search provider and translate the generic cookie into a replacement cookie that excludes the search service. The cookie-blocker component executes on the user computer, and is configured to intercept a generic cookie from a user application intended to be sent to the search provider.

### BRIEF DESCRIPTION OF THE DRAWINGS

FIG. 1 illustrates a networked environment in which the systems and methods for managing a search process can be implemented;

FIG. 2 illustrates a schematic of a system and method including an extension useable for managing a search process to provide depersonalized search, according to an example embodiment;

FIG. 3 is a flowchart of a method for managing a search process to provide depersonalized search, according to an example embodiment; and

FIG. 4 is a schematic diagram of an electronic computing system in which aspects of the present disclosure can be implemented.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general, the present disclosure relates to a search-depersonalization solution that works with one click and across browsers and platforms. This solution gives a user the option to prevent search providers from monitoring search activity and associating that activity with the user's personal profile while the user is logged into the providers' other services. Existing solutions to the problem of personalized search tracking are inconvenient. As an example, the “Private Browsing” and “Incognito” modes implemented by popular browsers require the user always remembers to open a new private window or tab and never signs into search providers' services when in these privacy modes. The search depersonalization of the present disclosure, on the other hand, blocks all personal tracking of search behavior without the need to use a particular browser or open new windows or tabs.

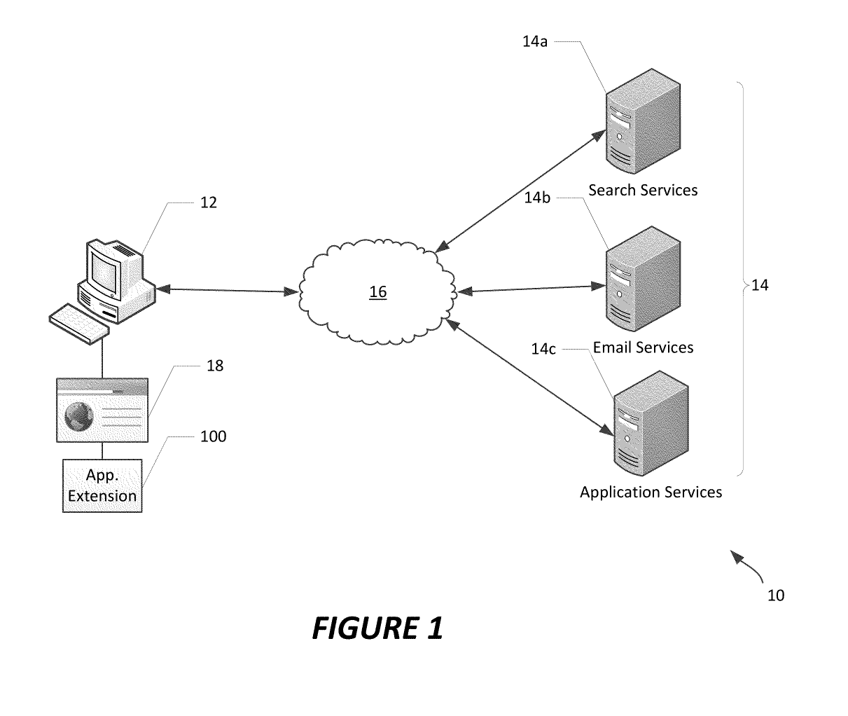

Referring now to FIG. 1, an example networked environment 10 in which the systems and methods for managing a search process can be implemented. The environment generally includes a user computing device 12, which can be, in various embodiments, a desktop or laptop computing device or a mobile computing device (e.g., a smartphone or tablet). The user computing device 12 is communicatively connected to a search service provider 14 via a network 16, such as the Internet. The search service provider 14 can be any of a variety of providers of search services 14a that also provide other services, such as email services 14b, application-hosting services 14c, or other types of services. Example search service providers can include, for example, Google, Microsoft, Yahoo, and others.

In general, a search service provider 14 is configured to allow for a single sign-on arrangement in which, once a user communicatively connects to that provider, cookies are exchanged with each communication by the user-identifying the user to the provider, as well as identifying the particular information transmitted by the user to the provider. In this way, a provider can avoid requiring the user to sign on to all of that provider's services each time the user switches among the services.

At the user computing device 12, a user may access services of the search service provider 14 via any of a number of methods. For example, the user computing device 12 can include a user application 18, which can correspond in various embodiments to a mobile application, a desktop application, or a mobile or desktop web browser.

In the embodiment shown, the user computing device 12 can include an application extension 100 useable to depersonalize at least a portion of the user's interactions with the search service provider 14. The application extension can be, in various embodiments, a browser extension, or an application extension adapted for use with a mobile or desktop application.

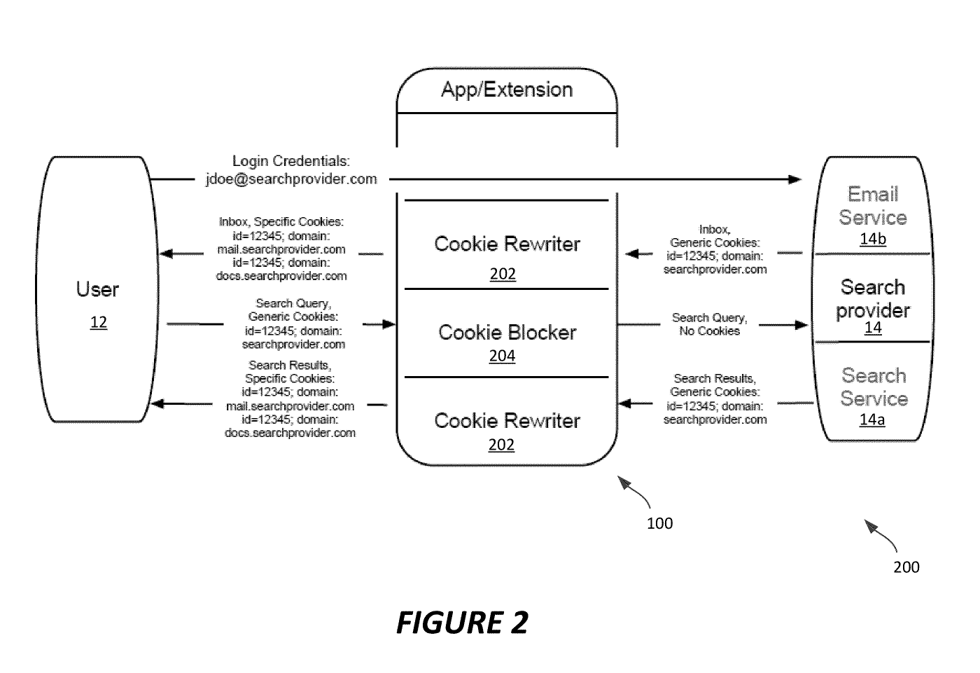

FIG. 2 illustrates a schematic of a system and method including an extension useable for managing a search process to provide depersonalized search, according to an example embodiment. The system 200 includes an application extension 100 as illustrated in FIG. 1, which resides between a user computing device 12 and a search service provider 14.

In the embodiment shown, the application extension 100 includes a cookie-rewriter component 202 and a cookie-blocker component 204. The cookie-rewriter component is configured to prevent a user application from setting generic cookies on behalf of a search service provider 14, when such generic cookies are received from the search service provider 14. In particular, if and when the extension 100 receives a generic cookie from the search service provider 14, the cookie-rewriter component is configured to replace those cookies with identical cookies that are rewritten to be limited to specific, non-search subdomains and paths. The generic cookies that are received at the cookie-rewriter component 202 are then not maintained by the user application at the user computing system 12. This generally prevents the typical circumstance in which a user logs into a search service provider's services, and receives generic cookies, such that the user is simultaneously logged in to many of the provider's services. Although this can be useful, it allows the search provider to associate the user's search-related information with the user-identifying account and therefore track a search history of that user. By disassociating at least the search service from the provider's other services, the user can search without being tracked.

In the embodiment shown, the cookie-blocker component 204 can be used to maintain a list of the subdomains and paths used by the search provider's search services. If the user issues a request that includes a generic cookie to one of the search subdomains or paths, the cookie-blocker component 204 strips the generic cookies out of the request. The generic cookies otherwise would be sent with a search, allowing the user searches to be tracked. In this way, a search-related cookie can be prevented from transmission to the search provider. Furthermore, other types of cookies, or portions of cookies, that include user-identifying information (generally referred to as “privacy-related cookies”) can be blocked or edited to avoid transmitting user-identifying information to a search service provider.

In various embodiments, the application extension can be installed, at least in part, at the user computing device 12; in alternative embodiments, a portion of the application extension 100 can be maintained at a server or other computing system remotely from the user computing device. For example, in some embodiments, the cookie-rewriter component 202 and cookie-blocker component 204 can either be included within the extension 100 on a user computing device 12, or could be maintained at a server remote from the user computing device and which acts as a proxy for the user computing device. Other arrangements are possible as well.

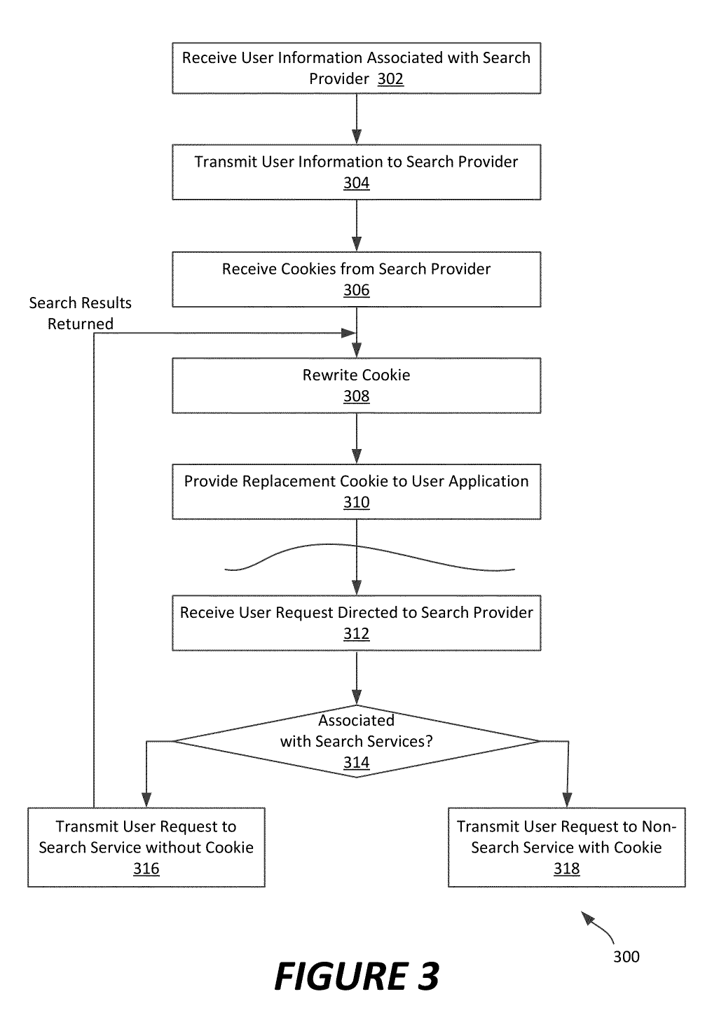

FIG. 3 is a flowchart of a method 300 for managing a search process to provide depersonalized search, according to an example embodiment. The method 300 is performed, in example embodiments, at an application extension, such as extension 100 of FIGS. 1-2 above. The method 300 is instantiated upon receipt of user information from a user application, and in particular receipt of user information targeted to one or more services of a search provider 14 (step 302). This can include for example, transmission of user credentials, as would occur in the event of a user logging in to an email server or application server associated with the search provider. The extension 100 would inspect the user credentials and provide them to the search provider 14 (step 304). In the example shown in FIG. 2, user login credentials “jdoe@searchprovider.com” is provided to the search provider.

In response to providing credentials, the extension 100 will receive one or more cookies from the service of the search provider (step 306). This can include, for example a generic cookie that can be used across all of the services provided by the search provider 14. In the example illustration of FIG. 2, the generic cookie can be received from an email service 14b associated with the search provider, and can include an ID (shown as “12345”), as well as a domain (shown as “searchprovider.com”). Other information can be returned as well, for example data associated with the service to which the user has opted to access.

It is noted that the ID and domain are associated with the user by the search provider, such that subsequent receipt of the cookie providing this identifying information to the search-provider service will allow that service to associate all activities with that common user, jdoe@searchprovider.com. Accordingly, at the extension 100 the one or more cookies can be inspected and, to the extent generic cookies have been received, those cookies can be edited or replaced with one or more replacement cookies (step 308). These replacement cookies can then be provided to the user application at the user computing device (step 310). This can be performed, for example, by a cookie-rewriter 202 such as the one shown in FIG. 2. In particular, where an application domain and an email domain are available separate from the search domain, the cookie-rewriter can create separate cookies for each. In the embodiment shown, the generic cookie having an ID of 12345 and a domain of searchprovider.com can be replaced by separate specific cookies for each of a number of domains associated with the search provider, but excluding the search domain. As shown, the single cookie is converted to separate cookies identifying a domain of mail.searchprovider.com and docs.searchprovider.com, respectively.

Some time after the user has previously logged in to one or more of the non-search services provided by the search provider 14, the extension 100 can receive a request from the user application at the user device 12 (step 312). The request can be, for example, a search request directed to the search provider, or a request for non-search services associated with the search provider. In the embodiment shown, the request is routed to a cookie-blocker component 204, which inspects the request to determine whether it is associated with search services or non-search services (step 314). If the request is associated with search services, the cookie-blocker will transmit the user request to the search provider 14, and in particular to the search services 14a of the search provider 14, without transmitting an identifying cookie therewith. The search results can then be returned to the user from the search provider.

In some embodiments, the search provider 14 will provide one or more cookies to the user alongside the search results, which will allow the search provider 14 to track the user searches. In such embodiments, the method discussed herein will allow for rewriting of these cookies as discussed above (returning to step 308).

In the particular example discussed in FIG. 2, a search query can be provided from a user application (e.g., application 18) on the user computing device 12 that includes query terms, as well as one or more generic cookies. The generic cookies can include, for example, a cookie having an ID of 12345 and domain of searchprovider.com. The cookie-blocker 204 operates, in step 314, to inspect and block the cookie, allowing the search query to pass to the search service 14a. On return, the search results can be provided, again with a generic cookie that can be inspected and rewritten as one or more service-specific cookies via the cookie-rewriter.

It is noted that if the user request is not associated with a search service, the cookie-blocker 204 will permit transmission of a generic or application-specific cookie to the non-search service of the search provider 14 (step 318). This allows the user to avoid having to log in each time he/she accesses non-search services of the search provider 14.

In various embodiments, the number and type of specific cookies that are generated by the cookie-rewriter 202 in response to receipt of a general cookie can vary; the specific cookies are determined by the subdomains and paths of non-search services provided by a search provider 14, which are maintained by the cookie-rewriter. In some example embodiments, the cookie-rewriter can be periodically updated to receive new subdomains and paths from a provider of the extension 100, for example via a remote server. Furthermore, other permutations of the arrangement discussed herein are possible as well, for example using the cookie-rewriter to replace the generic cookie included with a search query with a search-specific cookie associated with a different user, or a generic user.

Generally, the systems and processes of FIGS. 2-3 reverse single sign-on (SSO), and are controlled from the perspective of the user and user application. When a user logs into a search service, the user is issued specific cookies rather than generic cookies. Alternatively, generic cookies are issued but blocked for search queries at request time. The cookies are sent only to restricted subdomains (e.g., mail.google.com) and paths (e.g., google.com/calendar) not blanketly to the primary domain (e.g., google.com). The system implementing this reversal of SSO maintains a filter list of non-search services for each search provider. The list is referenced to determine which services can safely receive cookies. This process ensures search requests cannot be correlated with any logged-in profile state.

The systems and methods of the present disclosure can take a variety of forms. As noted above, in various embodiments, these can include desktop and mobile applications and browser extensions. In some embodiments, users can install the browser extensions, available for Chrome, Firefox, and Safari, with one click. The extensions are, in an example embodiment, written in HTML, CSS, and JavaScript. The cookie-manipulation code is, in an example embodiment, implemented in JavaScript.

Still further, although it is noted that embodiments of the present disclosure are provided relating to blocking of cookies from transmission to a search service provider, it is noted that other types of identifying information could be used by that search service provider as well, and blocking of those types of information is also contemplated by the present disclosure, in particular in the cookie-blocker and cookie-rewriter components of the extension 100. For example, browser-fingerprinting data, device- or digital-fingerprinting data, and persistent storage information (e.g., local storage, LSOs, etc.) can be inspected and its transmission to a search service provider can be blocked as well, using analogous components.

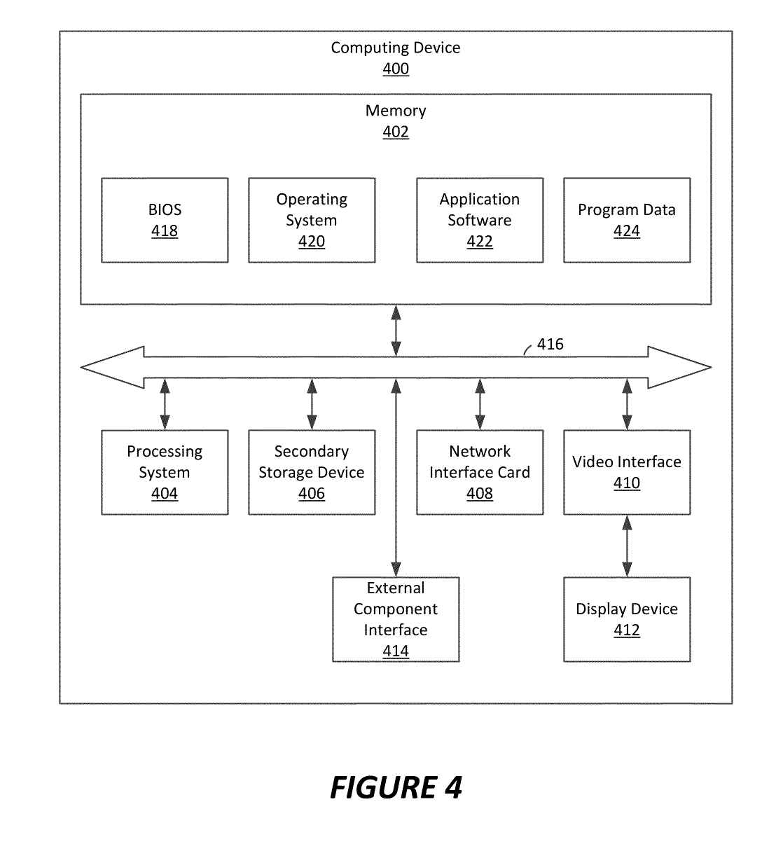

Referring now to FIG. 4, a schematic illustration of an example computing system in which aspects of the present disclosure can be implemented. The computing system 400 can represent, for example, any of computing systems 12, 14a-c illustrated in FIGS. 1-2, or implementing a proxy server that performs aspects of the operations of the extension 100 of FIGS. 1-3.

In the example of FIG. 4, the computing device 400 includes a memory 402, a processing system 404, a secondary storage device 406, a network interface card 408, a video interface 410, a display unit 412, an external component interface 414, and a communication medium 416. The memory 402 includes one or more computer storage media capable of storing data and/or instructions. In different embodiments, the memory 402 is implemented in different ways. For example, the memory 402 can be implemented using various types of computer storage media.

The processing system 404 includes one or more processing units. A processing unit is a physical device or article of manufacture comprising one or more integrated circuits that selectively execute software instructions. In various embodiments, the processing system 404 is implemented in various ways. For example, the processing system 404 can be implemented as one or more processing cores. In another example, the processing system 404 can include one or more separate microprocessors. In yet another example embodiment, the processing system 404 can include an application-specific integrated circuit (ASIC) that provides specific functionality. In yet another example, the processing system 404 provides specific functionality by using an ASIC and by executing computer-executable instructions.

The secondary storage device 406 includes one or more computer storage media. The secondary storage device 406 stores data and software instructions not directly accessible by the processing system 404. In other words, the processing system 404 performs an I/O operation to retrieve data and/or software instructions from the secondary storage device 406. In various embodiments, the secondary storage device 406 includes various types of computer storage media. For example, the secondary storage device 406 can include one or more magnetic disks, magnetic tape drives, optical discs, solid state memory devices, and/or other types of computer storage media.

The network interface card 408 enables the computing device 400 to send data to and receive data from a communication network. In different embodiments, the network interface card 408 is implemented in different ways. For example, the network interface card 408 can be implemented as an Ethernet interface, a token-ring network interface, a fiber optic network interface, a wireless network interface (e.g., WiFi, WiMax, etc.), or another type of network interface.

The video interface 410 enables the computing device 400 to output video information to the display unit 412. The display unit 412 can be various types of devices for displaying video information, such as a cathode-ray tube display, an LCD display panel, a plasma screen display panel, a touch-sensitive display panel, an LED screen, or a projector. The video interface 410 can communicate with the display unit 412 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 414 enables the computing device 400 to communicate with external devices. For example, the external component interface 414 can be a USB interface, a FireWire interface, a serial port interface, a parallel port interface, a PS/2 interface, and/or another type of interface that enables the computing device 400 to communicate with external devices. In various embodiments, the external component interface 414 enables the computing device 400 to communicate with various external components, such as external storage devices, input devices, speakers, modems, media player docks, other computing devices, scanners, digital cameras, and fingerprint readers.

The communications medium 416 facilitates communication among the hardware components of the computing device 400. In the example of FIG. 4, the communications medium 416 facilitates communication among the memory 402, the processing system 404, the secondary storage device 406, the network interface card 408, the video interface 410, and the external component interface 414. The communications medium 416 can be implemented in various ways. For example, the communications medium 416 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 402 stores various types of data and/or software instructions. For instance, in the example of FIG. 4, the memory 402 stores a Basic Input/Output System (BIOS) 418 and an operating system 420. The BIOS 418 includes a set of computer-executable instructions that, when executed by the processing system 404, cause the computing device 400 to boot up. The operating system 420 includes a set of computer-executable instructions that, when executed by the processing system 404, cause the computing device 400 to provide an operating system that coordinates the activities and sharing of resources of the computing device 400. Furthermore, the memory 402 stores application software 422. The application software 422 includes computer-executable instructions, that when executed by the processing system 404, cause the computing device 400 to provide one or more applications. The memory 402 also stores program data 424. The program data 424 is data used by programs that execute on the computing device 400.

Although particular features are discussed herein as included within an electronic computing device 400, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. However, such computer readable media, and in particular computer readable storage media, are generally implemented via systems that include at least some non-transitory storage of instructions and data that implements the subject matter disclosed herein.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Referring to FIGS. 1-4 generally, it is noted that the systems and methods of the present disclosure provide a number of advantages. For example, one fundamental advantage of the solution discussed in the present disclosure is ease of use—searchers are unwilling to sacrifice convenience for privacy. In particular, the present disclosure provides ease of use based on three properties: First, the user installs the search-depersonalization software once. The software requires no privacy preferences be manually configured. Second, the user no longer needs to open private windows or tabs or avoid signing into services. The depersonalized search is available in every window and tab and allows logging into non-search services. Third, the user is able to enjoy privacy across different browsers and platforms, including those on mobile devices.

Furthermore, reversing or otherwise preventing single sign-on has application beyond search depersonalization and search privacy. The method can be deployed whenever data sharing between services is undesired. The effect will be to stop content personalization or improve privacy. Moreover, the methods and systems of the present disclosure can enhance security. By reducing the scope of users' authentication tokens, the number of services that would be compromised in the event the tokens were compromised could also be reduced. In this way, services deemed more critical could be isolated and made to require separate authorization. Other cookie attributes might be manipulated to further limit access to critical services—e.g., the expires directive might be set to an earlier date.

The above specification, examples, and data provide a complete description of the manufacture and use of the composition of the invention. Since many embodiments of the invention can be made without departing from the spirit and scope of the invention, the invention resides in the claims hereinafter appended.

1. A method of managing a search process comprising:
receiving user information from a user application, the user information associated with a search provider maintaining search services and non-search services;
transmitting the user information to the search provider;
receiving one or more cookies from the search provider;
receiving a user request from a user application, the user request addressed to the search provider;
comparing the user request to a list of non-search services maintained by the search provider, and
upon determining that the user request is associated with a search service, transmitting the user request to the search service without transmitting the one or more cookies.

2. The method of claim 1, further comprising, upon determining that a second request is associated with a non-search service, allowing the user application to send cookies to a subdomain or path associated with the search provider that relates to the non-search service.

3. The method of claim 1, wherein the cookies are search-related cookies.

4. The method of claim 1, wherein the cookies are privacy-related cookies.

5. The method of claim 1, wherein comparing the user request occurs in a browser extension.

6. The method of claim 1, wherein the user application comprises a desktop application.

7. The method of claim 1, wherein the user application comprises a mobile application.

8. The method of claim 1, further comprising transmitting the one or more cookies to the user application.

9. The method of claim 1, wherein the user application comprises a web browser.

10. A method of managing a search process comprising:
receiving user login information from a user application, the user login information associated with a data provider;
transmitting the user login information to the data provider;
receiving a user request from a user application, the user request addressed to the data provider and associated with a service provided by the data provider, the user request including user-identifying information;
based at least in part on an identity of the service, transmitting the user request to the data provider without transmitting the user-identifying information.

11. The method of claim 10, wherein the data provider comprises a search provider maintaining search services and non-search services.

12. The method of claim 11, wherein the service associated with the user request comprises a search service.

13. The method of claim 10, further comprising:
receiving a second user request from a user application, the second user request addressed to the data provider and associated with a second service different from the service;
transmitting the user request to the data provider, the user request including user-identifying information.

14. An application extension comprising:
a cookie-rewriter component executing on a user computer, the cookie-rewriter maintaining a list of a plurality of subdomains and paths associated with non-search services of a search provider; the cookie-rewriter configured to receive a generic cookie from a service of a search provider and translate the generic cookie into a replacement cookie that excludes the search service; and
a cookie-blocker component executing on the user computer, the cookie-blocker configured to intercept a generic cookie from a user application intended to be sent to the search provider.

15. The application extension of claim 14, wherein the application extension comprises at least one of: a browser extension, a mobile application extension, and a desktop application extension.

16. The application extension of claim 14, wherein the generic cookie is useable by the search provider to identify the user across both search services and non-search services.

17. The application extension of claim 14, wherein the replacement cookie is limited to the list of the plurality of subdomains and paths associated with non-search services of the search provider.

18. The application extension of claim 14, wherein the application extension is installable within the user application.

19. The application extension of claim 14, wherein, in the absence of the cookie-blocker, the user application transmits the generic cookie to the search provider.

20. The application extension of claim 14, wherein the cookie-rewriter is configured to provide the replacement cookie to the user application.
